(19) United States
(12) Patent Application Publication
(10) Pub. No.: US 2025/0355326 A1
(43) Pub. Date: Nov. 20, 2025

(54) OPTICAL SYSTEM

(71) Applicant: TDK TAIWAN CORP., Taoyuan City (TW)

(72) Inventors: Kai-Po FAN, Taoyuan City (TW); Man-Ting LU, Taoyuan City (TW); Yu-Che KAO, Taoyuan City (TW); Shou-Jen LIU, Taoyuan City (TW)

(21) Appl. No.: 19/209,258

(22) Filed: May 15, 2025

Related U.S. Application Data
(60) Provisional application No. 63/648,834, filed on May 17, 2024.

(51) Int. Cl. G03B 13/36; G02B 7/09; G03B 5/00; G03B 7/26

(52) U.S. Cl. CPC G03B 13/36; G02B 7/09; G03B 5/00; G03B 7/26; G03B 2205/0007; G03B 2205/0069

(57) ABSTRACT

An optical system is provided, including a first optical module and a circuit assembly. The first optical module is for carrying a first optical element. The circuit assembly is for electrically connecting an external circuit. The circuit assembly includes an input terminal, an output terminal, and a flexible portion. The input terminal and the output terminal are movable relative to each other. The input terminal is movably connected to the output terminal via the flexible portion. The input terminal is at least partially fixedly connected to the first optical module.

### CROSS REFERENCE TO RELATED APPLICATIONS

This application claims the benefit of U.S. Provisional Application No. 63/648,834, filed 2024 May 17, the entirety of which is incorporated by reference herein.

### BACKGROUND OF THE INVENTION

### Field of the Invention

The present invention relates to an optical system, and, in particular, it relates to an optical system having a plurality of optical modules and a flexible portion.

### Description of the Related Art

With the advancement of technology, many modern electronic devices (such as computers or tablet computers) are equipped with photography or video recording functions. As the use of these electronic devices becomes increasingly widespread, the development of more stable and higher-quality optical performance has been paralleled by a trend toward more convenient and slimmer designs, in order to provide users with greater variety and choice.

However, when optical elements with longer focal lengths (such as lenses) are required to be installed in the aforementioned electronic devices, this can lead to an increase in device thickness, which is unfavorable for achieving slimness and stability. Moreover, due to various imaging requirements, these electronic devices need to support functions such as optical image stabilization, zoom adjustment, and light intake control. However, motors that provide different functions may not be compatible with each other.

In view of the foregoing, how to design an optical system that enables electronic devices to be slim and stable, while also providing better compatibility to accommodate a wider variety of modules, has become an important issue.

### BRIEF SUMMARY OF THE INVENTION

The terms “embodiment” and similar expressions (e.g., implementation, configuration, feature, example, and option) are intended to broadly refer to all subject matter of the present invention and the following claims. Statements including these terms should not be interpreted as limiting the subject matter described herein or the meaning or scope of the following claims. The embodiments covered by this disclosure are defined by the claims rather than the content of the invention. The content of the invention is a high-level overview of various aspects of the invention and introduces some of the concepts further described in the following detailed embodiment sections. This content is not intended to identify key or essential features of the claimed subject matter, nor is it intended to be used in isolation to determine the scope of the claimed subject matter. The subject matter should be understood by reference to the appropriate portions of the full specification of the invention, any or all drawings, and each of the claims.

According to certain aspects of the present disclosure, an optical system is provided. The optical system includes a first optical module and a circuit assembly. The first optical module for carrying a first optical element. The circuit assembly is for electrically connecting to an external circuit.

According to certain aspects of the present disclosure, the circuit assembly includes an input terminal, an output terminal, and a flexible portion. The input terminal and the output terminal are movable relative to each other. The input terminal is movably connected to the output terminal via the flexible portion. The input terminal is at least partially fixedly connected to the first optical module.

The foregoing summary is not intended to present every embodiment or every feature of the invention. Rather, the above summary provides examples of some of the novel aspects and characteristics disclosed herein. When taken together with the accompanying drawings and the appended claims, the representative embodiments and modes described in detail below for practicing the invention will make the above and other features and advantages of the invention more apparent. Additional features of the invention will be apparent to those of ordinary skill in the art upon reading the detailed description of various embodiments provided below, with reference to the drawings and the simplified descriptions of symbols therein.

### BRIEF DESCRIPTION OF THE DRAWINGS

The present invention and its advantages will be better understood from the following description of example embodiments, taken in conjunction with the accompanying drawings. These drawings illustrate only example embodiments and are not to be considered limiting with respect to any embodiment or the scope of the claims.

FIG. 1 is a perspective view of an example optical system, according to certain aspects of the present disclosure.

FIG. 2 is a perspective view of the example optical system, according to certain aspects of the present disclosure, with the housing removed for illustrative purposes.

FIG. 3 is an exploded perspective view of the example optical system, according to certain aspects of the present disclosure.

FIG. 4 is a top view of the example optical system showing the first optical element in a first position, according to certain aspects of the present disclosure, with the housing and top cover removed and the first optical element shown in dashed lines for illustrative purposes.

FIG. 5 is a top view of the example optical system showing the first optical element in a second position, according to certain aspects of the present disclosure, with the housing and top cover removed and the first optical element shown in dashed lines for illustrative purposes.

FIG. 6 is a cross-sectional view of the example optical system taken along line B-B of FIG. 1, according to certain aspects of the present disclosure.

FIG. 7 is a top view of the example optical system showing only the electronic component portions of the first optical module and the second optical module, according to certain aspects of the present disclosure, with the coil of the driving assembly shown in dashed lines for illustrative purposes.

FIG. 8 is a cross-sectional view of the example optical system taken along line A-A of FIG. 2, according to certain aspects of the present disclosure, with the housing removed for illustrative purposes.

FIG. 9 is a cross-sectional view of the example optical system taken along line C-C of FIG. 2, according to certain aspects of the present disclosure, with the housing removed for illustrative purposes.

### DETAILED DESCRIPTION OF THE INVENTION

Various embodiments are described with reference to the accompanying drawings, in which like reference numerals are used to designate similar or equivalent elements throughout the figures. The drawings are not necessarily drawn to scale and are provided solely to illustrate the features and characteristics of the present disclosure. It should be understood that numerous specific details, relationships, and methods are set forth to provide a comprehensive understanding. However, those skilled in the art will readily appreciate that various embodiments may be practiced without one or more of the specific details, or with alternative methods. In some instances, well-known structures or operations are not described in detail for illustrative purposes. The various embodiments are not limited to the illustrated sequence of actions or events, as certain actions may occur in a different order and/or concurrently with other actions or events. Moreover, not all illustrated actions or events are necessarily required to implement certain features and aspects of the present disclosure.

For the purposes of the present embodiment, unless explicitly stated otherwise, the singular includes the plural and vice versa. The term “comprising” means “including but not limited to.” Additionally, approximation terms such as “about,” “almost,” “substantially,” and “approximately” may be understood to mean, for example, “at,” “near,” “nearly at,” “within 3-5% of,” “within acceptable manufacturing tolerances,” or any logical combination thereof. Furthermore, the terms “vertical” or “horizontal” are intended to include directions within, for example, 3-5% deviation from vertical or horizontal. Directional terms such as “top,” “bottom,” “left,” “right,” “above,” and “below” are intended to refer to directions as depicted in the reference drawings, understood from the context of the referenced object or element's typical orientation, or other such descriptive context.

It should be understood that although terms such as “first,” “second,” etc., may be used to describe various elements, layers, and/or portions, such elements, layers, and/or portions should not be limited by these terms. These terms are only used to distinguish one element, layer, or portion from another. Thus, a first element, layer, or portion discussed below could likewise be referred to as a second element, layer, or portion without departing from the teachings of certain embodiments of the present disclosure. For brevity, terms like “first” and “second” may be omitted in the specification when distinguishing between components is unnecessary. The first and/or second elements recited in the claims can be construed to correspond to any suitable elements described in the specification, without departing from the scope of the appended claims.

It should be noted that the technical solutions provided in different embodiments described below may be interchangeably applied, combined, or used in hybrid form, so as to constitute another embodiment without departing from the spirit of the present disclosure.

The present disclosure relates to an optical system that includes a plurality of optical modules and a flexible portion. A driving assembly actuates a movable part and an optical element to adjust the imaging of the optical system to accommodate different photography requirements. The disclosed optical system offers improved compatibility, is adaptable to a wider variety of lens driving modules, and simplifies the design of control circuits.

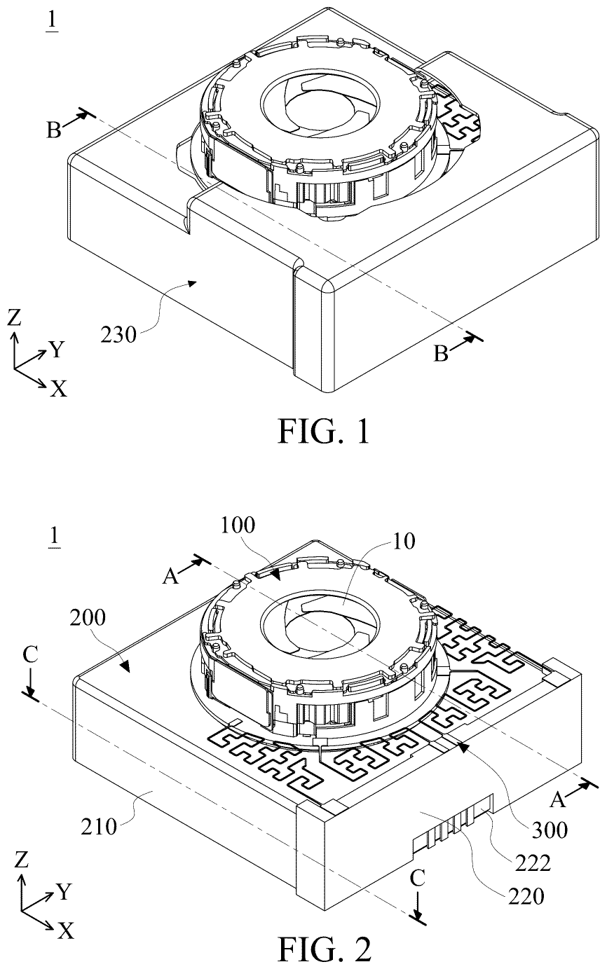

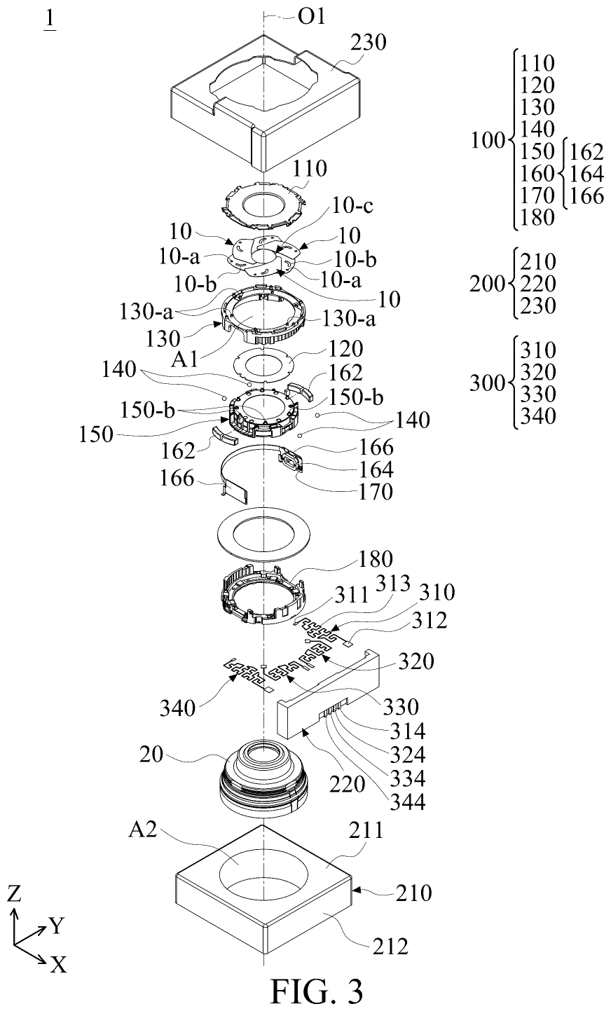

Referring first to FIG. 1 through FIG. 3, FIG. 1 is a perspective view of an example optical system 1, according to certain aspects of the present disclosure. FIG. 2 is another perspective view of the optical system 1 with the housing 230 removed for illustrative purposes. FIG. 3 is an exploded perspective view of the example optical system 1, according to certain aspects of the present disclosure.

The optical system 1 includes a first optical module 100, a second optical module 200, and a circuit assembly 300. The first optical module 100 carries a first optical element 10, and the second optical module 200 carries a second optical element 20. The circuit assembly 300 is configured to electrically connect to an external circuit (e.g., a lens driving device). The first optical module 100 is disposed on top of the second optical module 200, and the first optical module 100 is configured to drive the first optical element 10 to move.

The first optical elements 10 may be a plurality of optical blades. In this embodiment, the first optical elements 10 are six optical blades. Six of the first optical elements 10 together define an aperture 10-c. Incident light passes through the aperture 10-c into the second optical element 20. The driving of the first optical element 10 will be described in detail below.

The second optical element 20 may be, for example, an optical lens. It is disposed on a lens driving device (not shown) and achieves functions such as autofocus (AF) and optical image stabilization (OIS) through the lens driving device. The lens driving device includes a plurality of driving circuit portions (not shown) to operate the device. The first optical module 100 may be mounted on the second optical element 20 of the second optical module 200 and move together with the second optical element 20 to achieve autofocus and optical image stabilization functions.

The first optical module 100 includes a first accommodating space A1, a top cover 110, a light-shielding element 120, an upper frame 130, a plurality of guiding elements 140, a movable part 150, a driving assembly 160, a circuit board assembly 170, and a base 180.

The first accommodating space A1 houses the first optical element 10. The movable part 150 is connected to the first optical element 10 and is configured to move relative to the upper frame 130 and the base 180. The driving assembly 160 drives the movement of the movable part 150. The upper frame 130 is fixedly connected to the base 180. The movable part 150 is movably connected to the upper frame 130 via the guiding elements 140. Incident light from the outside travels along an incident axis O1 through the optical system 1 to reach the second optical element 20.

The top cover 110 is disposed above the first optical element 10. The first optical element 10 is located between the light-shielding element 120 and the top cover 110. The top cover 110 at least partially covers the first optical element 10, thereby protecting the components inside the optical system 1 from external impacts. The light-shielding element 120 may be made of light-absorbing material, such as SOMA.

The upper frame 130, the movable part 150, the driving assembly 160, and the base 180 are sequentially arranged when viewed along the incident axis O1 of the incident light.

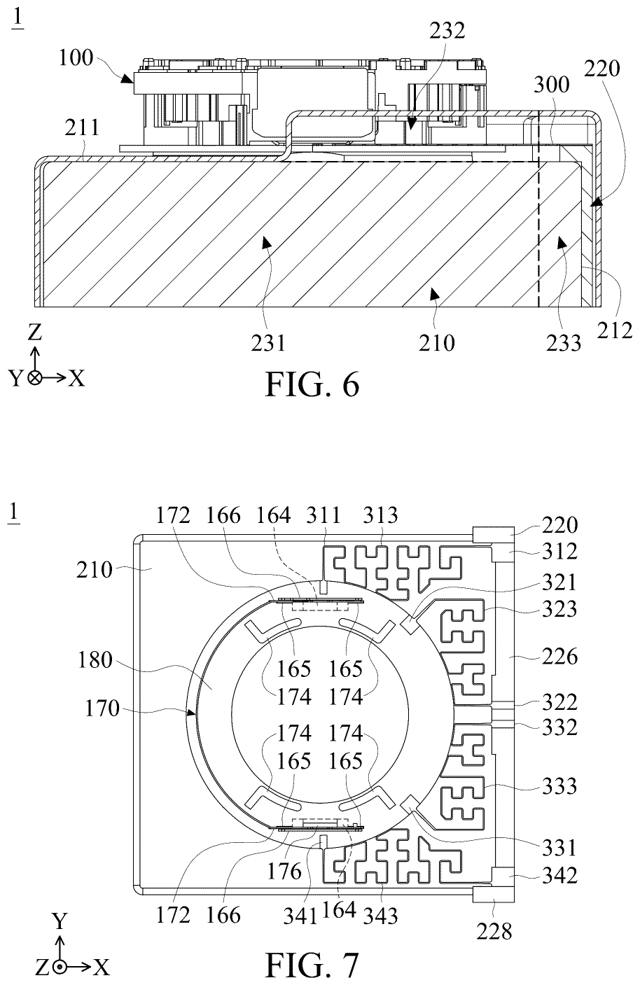

The driving assembly 160 includes a plurality of magnetic elements 162, a plurality of coils 164, and a plurality of magnetic-conductive elements 166. In this embodiment, there are two magnetic elements 162, two coils 164, and two magnetic-conductive elements 166. Each coil 164 has two connection terminals 165 (see FIG. 6) for connection to the circuit assembly 300.

The magnetic elements 162 are disposed on the movable part 150. The coils 164 are disposed on the base 180. Through the electromagnetic driving force generated between the magnetic elements 162 and the coils 164, the magnetic elements 162 move relative to the coils 164. As a result, the movable part 150 moves relative to the base 180 and the upper frame 130, which is fixed to the base 180, thereby the movable part 150 drives the movement of the first optical element 10. Thus, the electromagnetic driving force generated between the magnetic elements 162 and the coils 164 drives the movable part 150 to move the first optical element 10 relative to the base 180 and the upper frame 130.

In this embodiment, four guiding elements 140 are provided between the movable part 150 and the upper frame 130, adjacent to the magnetic elements 162. The movable part 150 is connected to the upper frame 130 via the four guiding elements 140.

When the movable part 150 is driven by the driving assembly 160 to move, the guiding elements 140 roll between the upper frame 130 and the movable part 150, allowing the movable part 150 to move smoothly relative to the upper frame 130.

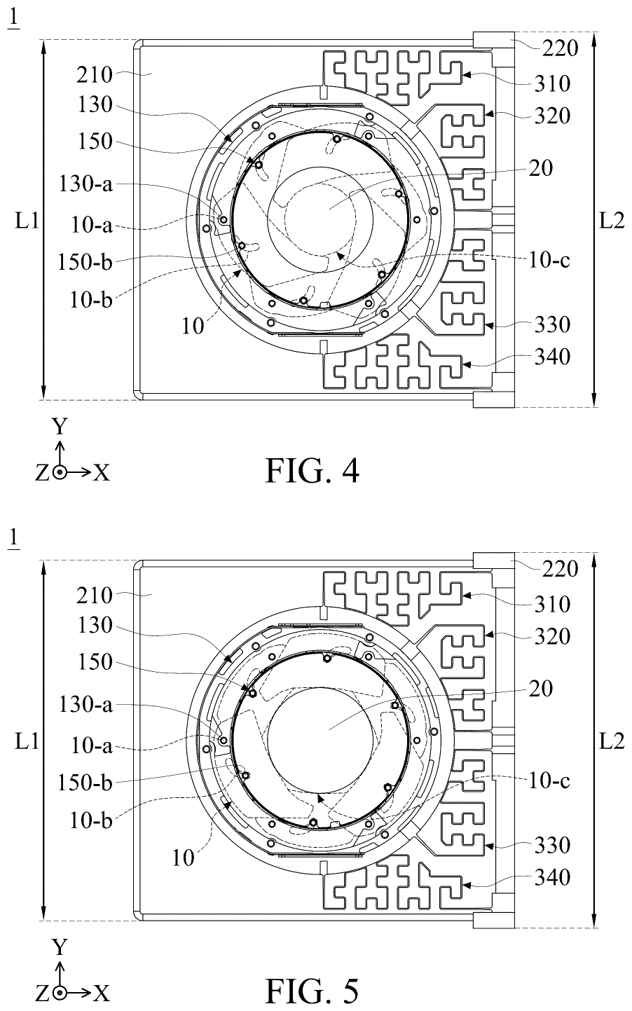

The movement of the movable part 150 relative to the upper frame 130 and the base 180 is described below with reference to FIG. 3 to FIG. 5. FIG. 4 is a top view of the optical system 1, according to certain aspects of the present disclosure, in which the first optical element 10 is in a first position. For illustrative purposes, the housing 230 and the top cover 110 are removed, and the first optical element 10 is shown in dashed lines. FIG. 5 is a top view of the optical system 1, according to certain aspects of the present disclosure, in which the first optical element 10 is in a second position. For illustrative purposes, the housing 230 and the top cover 110 are removed, and the first optical element 10 is shown in dashed lines.

The movable part 150 is connected to six first optical elements 10. Each of the six first optical elements 10 has a hole 10-a and an elongated hole 10-b for connecting the movable part 150 and the upper frame 130, as will be further explained below.

The movable part 150 and the first optical elements 10 move relative to the upper frame 130. The movable part 150 has a plurality of protrusions 150-b that pass through the elongated holes 10-b of the first optical elements 10 and are movable within the elongated holes 10-b.

The upper frame 130 has a plurality of protrusions 130-a that pass through the holes 10-a of the first optical elements 10 and are rotatable within the holes 10-a. Through the engagement of the protrusions 150-b and 130-a with the elongated holes 10-b and holes 10-a, the first optical elements 10 are connected to both the movable part 150 and the upper frame 130.

When the movable part 150 is driven to move by the driving assembly 160, the plurality of protrusions 150-b of the movable part 150 move within the elongated holes 10-b of the first optical elements 10, and the plurality of protrusions 130-a of the upper frame 130 rotate within the holes 10-a of the first optical elements 10, thereby driving the movement of the first optical elements 10. By moving the first optical elements 10, the size of the aperture 10-c formed by the first optical elements 10 may be adjusted.

At the first position shown in FIG. 4, the aperture 10-c formed by the first optical elements 10 is relatively small. Accordingly, in this position, a smaller amount of incident light passes through the aperture 10-c to reach the second optical element 20.

At the second position shown in FIG. 5, the aperture 10-c formed by the first optical elements 10 is larger than that in the first position shown in FIG. 4. Therefore, in the second position, a greater amount of incident light passes through the aperture 10-c to reach the second optical element 20.

Next, please refer back to FIG. 3. The magnetic-conductive element 166 corresponds to the magnetic element 162 and is disposed on the circuit board assembly 170, corresponding to both the coil 164 and the magnetic element 162. The magnetic-conductive element 166 and the magnetic element 162 provide a magnetic attraction force that draws the movable part 150 toward the guiding element 140, thereby enabling the movable part 150 to abut against the guiding element 140 and move stably relative to the upper frame 130.

The second optical module 200 includes a second accommodating space A2, a protective frame 210, a fixed frame 220, and a housing 230. The protective frame 210 accommodates the second optical element 20.

The protective frame 210 includes a first sidewall 211 and a second sidewall 212. The first sidewall 211 is at least partially located between the second accommodating space A2 and the circuit assembly 300. The first optical module 100 is at least partially disposed within the second accommodating space A2. The first sidewall 211 may at least partially be covered with a light-shielding material, such as SOMA. The inner surface of the housing 230 may also be at least partially covered with a light-shielding material, such as SOMA.

Next, please refer to both FIG. 3 and FIG. 6. FIG. 6 is a sectional view of the example optical system 1 along line B-B in FIG. 1, according to certain aspects of the present disclosure. The housing 230 includes a first housing space 231, a second housing space 232, and a third housing space 233. The first housing space 231 communicates with both the second housing space 232 and the third housing space 233. The first housing space 231 is configured to accommodate the protective frame 210, the second housing space 232 is configured to accommodate a portion of the circuit assembly 300, and the third housing space 233 is configured to accommodate the fixed frame 220. When viewed in a direction parallel to the first sidewall 211, the first housing space 231 and the second housing space 232 do not overlap. When viewed in a direction parallel to the second sidewall 212, the first housing space 231 and the third housing space 233 do not overlap. When viewed in a direction normal to the second sidewall 212, the first housing space 231 and the third housing space 233 at least partially do not overlap, and the second housing space 232 and the third housing space 233 at least partially do not overlap. The structural design of the housing 230 may effectively protect the fixed frame 220 and the circuit assembly 300, making them less prone to damage from external impacts and thereby improving the reliability of the optical system 1.

The second sidewall 212 is at least partially located between the second accommodating space A2 and the circuit assembly 300. The first sidewall 211 and the second sidewall 212 are not parallel to each other. The second sidewall 212 is attached to the fixed frame 220. The fixed frame 220 includes a groove 222 (see FIG. 2) that accommodates a portion of the circuit assembly 300.

Next, please refer to FIG. 3 and FIG. 7 together. FIG. 7 is a top view of the example optical system 1, according to certain aspects of the present disclosure. For illustrative purposes, only the electronic component portions of the first optical module 100 and the second optical module 200 are shown, and the coils 164 of the driving assembly 160 are illustrated with dashed lines.

The circuit board assembly 170 includes two coil terminals 172, a plurality of circuit components 174, and a control component 176.

The coils 164 are fixed to the coil terminals 172. The control component 176 is fixed to one of the two coil terminals 172. In this embodiment, the control component 176 is electrically connected to the coils 164, and further electrically connected to the circuit components 174 through the connection terminals 165. The circuit components 174 are electrically connected to the circuit assembly 300, and the circuit assembly 300 is electrically connected to the external circuit.

The circuit assembly 300 is electrically connected to the driving assembly 160 via the circuit board assembly 170. The circuit assembly 300 is not disposed within the second accommodating space A2. Instead, the circuit assembly 300 is disposed on the first sidewall 211 and the fixed frame 220.

The circuit assembly 300 includes circuit elements 310, 320, 330, and 340. Each circuit element 310, 320, 330, 340 respectively includes an input terminal, an output terminal, a flexible portion, and an external terminal. These are respectively the input terminals 311, 321, 331, 341; the output terminals 312, 322, 332, 342; the flexible portions 313, 323, 333, 343; and the external terminals 314, 324, 334, 344 (see FIG. 3).

Each input terminal is movably connected to the corresponding output terminal via its respective flexible portion. For example, the input terminal 311 is movably connected to the output terminal 312 via the flexible portion 313; the input terminal 321 is movably connected to the output terminal 322 via the flexible portion 323; the input terminal 331 is movably connected to the output terminal 332 via the flexible portion 333; and the input terminal 341 is movably connected to the output terminal 342 via the flexible portion 343. The flexible portions are formed of flexible materials, allowing relative movement between the respective input and output terminals. For example, the input terminal 311 may move relative to the output terminal 312, the input terminal 321 may move relative to the output terminal 322, the input terminal 331 may move relative to the output terminal 332, and the input terminal 341 may move relative to the output terminal 342. The input terminals 311, 321, 331, and 341 are at least partially and fixedly connected to the first optical module 100. The external terminals 314, 324, 334, and 344 are positioned within the groove 222. A metal circuit structure is embedded in the fixed frame 220 to connect the external terminals 314, 324, 334, and 344. The output terminals 312, 322, 332, and 342 are electrically connected to the external terminals 314, 324, 334, and 344 via the metal circuit structure within the fixed frame 220 and are further electrically connected to the external circuit.

Specifically, the groove 222 includes a first groove space 2221 and a second groove space 2222. The first groove space 2221 communicates with the second groove space 2222. The external terminals 314, 324, 334, and 344 are housed within the first groove space 2221, and not within the second groove space 2222. When viewed in a direction normal to the second sidewall 212 (e.g., along the −X-axis), the first groove space 2221 and the external terminals 314, 324, 334, and 344 at least partially overlap, and the second groove space 2222 and the external terminals 314, 324, 334, and 344 also at least partially overlap. The overlapping area between the external terminals 314, 324, 334, 344 and the first groove space 2221 is greater than the overlapping area between the external terminals 314, 324, 334, 344 and the second groove space 2222. Through the structural design of the first groove space 2221 and the second groove space 2222, electrical connection of the external terminals 314, 324, 334, and 344 to the external circuit is more convenient and reliable.

When viewed in a direction perpendicular to the first sidewall 211, the fixed frame 220 does not overlap the flexible portions 313, 323, 333, and 343.

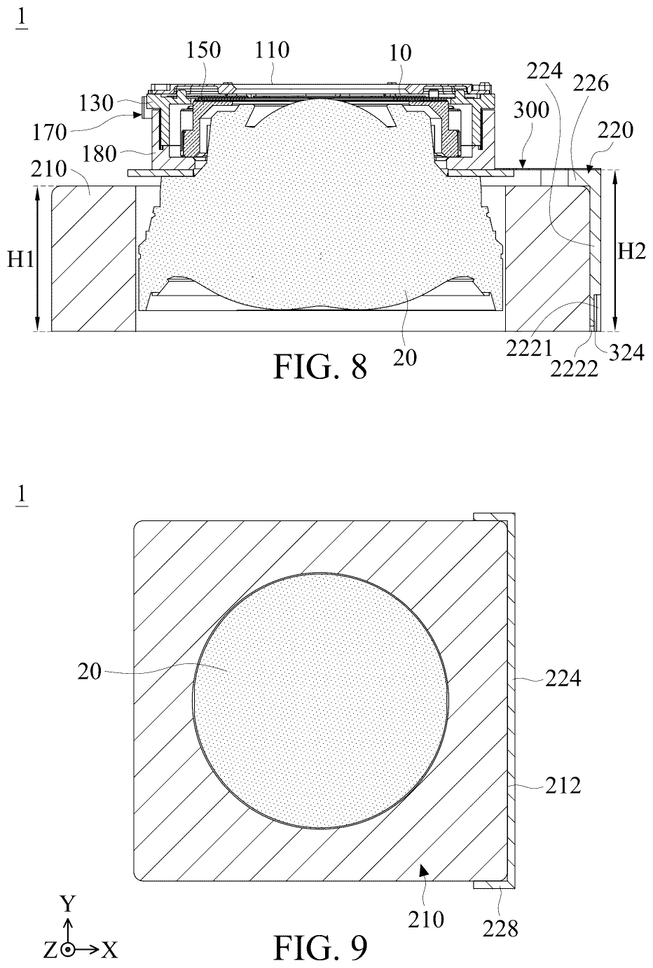

Next, please refer to FIG. 7, FIG. 8, and FIG. 9 together. FIG. 8 is a sectional view of the example optical system 1 along line A-A of FIG. 2, according to certain aspects of the present disclosure. For illustrative purposes, the housing 230 is removed. FIG. 9 is a sectional view of the example optical system 1 along line C-C of FIG. 2, according to certain aspects of the present disclosure. For illustrative purposes, the housing 230 is removed.

As shown in FIG. 8, the height H2 of the fixed frame 220 is greater than the height H1 of the protective frame 210. When the first optical module 100 moves relative to the second optical module 200, the height difference between the height H2 and the height H1 provides a movement space, and the flexible portions 313, 323, 333, 343 of the circuit assembly 300 provide flexibility during movement.

The length L2 of the fixed frame 220 is greater than the length L1 of the protective frame 210. During assembly, the protective frame 210 is placed within the fixed frame 220, i.e., the second sidewall 212 is fixedly attached to the fixed frame 220 and is covered by the fixed frame 220. The fixed frame 220 includes a main frame 224, a top frame 226, and a side frame 228. The main frame 224 corresponds to the second sidewall 212, and the groove 222 is formed on the main frame 224. The main frame 224 is connected to both the top frame 226 and the side frame 228. The output terminals 312, 322, 332, 342 may be disposed on the top frame 226. The side frame 228 does not contact the circuit assembly 300. As shown in FIG. 9, when viewed in a direction perpendicular to the first sidewall 211, the main frame 224 and the side frame 228 do not overlap the protective frame 210, while the top frame 226 at least partially overlaps the protective frame 210. When viewed in a direction parallel to both the first sidewall 211 and the second sidewall 212 (e.g., along the +Y-axis), the main frame 224 and the top frame 226 do not overlap the protective frame 210, while the side frame 228 at least partially overlaps the protective frame 210. This structural design enables the fixed frame 220 to be reliably mounted on the protective frame 210.

Through the above embodiment, the optical system 1 is advantageously mounted on a lens driving device. Specifically, in the present embodiment, there is no need to additionally design the circuitry for driving the movable part 150 and the first optical element 10 within the lens driving device that carries the second optical element 20. This avoids complicating the structural design of the lens driving device. Furthermore, with the circuit assembly 300 and the circuit board assembly 170 of the optical system 1, the driving circuit part of the lens driving device is arranged in the groove 222 of the fixed frame 220, thereby simplifying and facilitating the circuit design for controlling both the optical system 1 and the lens driving device.

In summary, the present invention provides an optical system comprising a first optical module, a second optical module, and a circuit assembly. The movement of the driving assembly drives the movable part to move relative to the base. As such, the position of the blades is adjusted to control the amount of incident light reaching the optical element, allowing adaptation to various photography requirements and providing more stable optical quality.

At the same time, with the design of the protective frame and the circuit assembly, the optical system is more easily mounted on a lens driving device. The structural design of the movable part and the first optical element in the optical system is not affected by the lens driving device, enabling compatibility with lens driving devices of various sizes. Furthermore, the circuit design for driving the movable part and the first optical element may be kept independent from the circuit design of the lens driving device, thereby simplifying the overall control circuit design.

Although one or more embodiments of the present invention have been illustrated and described, those skilled in the art, after reading and understanding this specification and the accompanying drawings, will appreciate equivalents and modifications. Moreover, while a particular feature of the invention may have been disclosed in the context of only one of several embodiments, such a feature may be combined with one or more other features of other embodiments as may be desirable and advantageous for a given or particular application.

Although various embodiments of the present invention have been described above, it should be understood that they are presented by way of example and not limitation. Various modifications may be made without departing from the spirit or scope of the invention as disclosed herein. Accordingly, the breadth and scope of the invention should not be limited by any of the above-described embodiments. Rather, the scope of the invention should be defined by the following claims and their equivalents.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Furthermore, the terms “including,” “having,” “has,” “with,” and any variations thereof as used in the description and/or the claims are intended to cover inclusively in a manner similar to the term “comprising.”

What is claimed is:

1. An optical system, comprising:
a first optical module, configured to carry a first optical element; and
a circuit assembly, configured to electrically connect the first optical module to an external circuit.

2. The optical system as claimed in claim 1, wherein the circuit assembly comprises:
an input terminal;
an output terminal, wherein the input terminal and the output terminal are movable relative to each other; and
a flexible portion, wherein the input terminal is movably connected to the output terminal via the flexible portion;
wherein the input terminal is at least partially fixedly connected to the first optical module.

3. The optical system as claimed in claim 2, further comprising a second optical module, wherein:
the first optical module is disposed on the second optical module;
the first optical module comprises a driving assembly, and the driving assembly is configured to drive the first optical element to move; and
the second optical module is configured to drive the first optical module to move.

4. The optical system as claimed in claim 3, wherein the second optical module comprises:
a second accommodating space for accommodating a second optical element; and
a protective frame having a first side wall, wherein the first side wall is at least partially located between the second accommodating space and the circuit assembly.

5. The optical system as claimed in claim 4, wherein the protective frame further comprises a second side wall, wherein:
the second side wall is at least partially located between the second accommodating space and the circuit assembly; and
the first side wall and the second side wall are not parallel to each other.

6. The optical system as claimed in claim 4, wherein:
the first optical module has a first accommodating space for accommodating the first optical element; and
the first optical module is at least partially located within the second accommodating space.

7. The optical system as claimed in claim 4, wherein:
the circuit assembly is electrically connected to the driving assembly; and
the circuit assembly is not disposed within the second accommodating space.

8. The optical system as claimed in claim 5, wherein the second optical module further comprises a fixed frame, wherein:
the fixed frame comprises a groove;
the circuit assembly further comprises an external terminal, which is disposed within the groove;
the output terminal is electrically connected to the external circuit via the external terminal; and
a height of the fixed frame is greater than a height of the protective frame.

9. The optical system as claimed in claim 8, wherein:
a length of the fixed frame is greater than a length of the protective frame; and
the first side wall is partially covered with a light-shielding material.

10. The optical system as claimed in claim 8, wherein:
the second side wall is attached to the fixed frame; and
when viewed in a direction perpendicular to the first side wall, the fixed frame and the flexible portion do not overlap.

11. The optical system as claimed in claim 8, wherein the second optical module further comprises a housing, and the housing includes:
a first housing space, accommodating the protective frame;
a second housing space, accommodating a portion of the circuit assembly; and
a third housing space, accommodating the fixed frame, wherein the first housing space is in communication with the second housing space and the third housing space.

12. The optical system as claimed in claim 11, wherein when viewed in a direction parallel to the first side wall, the first housing space and the second housing space do not overlap.

13. The optical system as claimed in claim 11, wherein when viewed in a direction parallel to the second side wall, the first housing space and the third housing space do not overlap.

14. The optical system as claimed in claim 11, wherein when viewed in a direction parallel to a normal direction of the second side wall, the first housing space and the third housing space at least partially do not overlap, and the second housing space and the third housing space at least partially do not overlap.

15. The optical system as claimed in claim 8, wherein the groove comprises a first groove space and a second groove space, the first groove space is in communication with the second groove space, the external terminal is accommodated within the first groove space and is not accommodated within the second groove space.

16. The optical system as claimed in claim 15, wherein when viewed in the direction parallel to the normal direction of the second side wall, the first groove space and the external terminal at least partially overlap, the second groove space and the external terminal at least partially overlap, and an overlapping area between the external terminal and the first groove space is greater than an overlapping area between the external terminal and the second groove space.

17. The optical system as claimed in claim 8, wherein the fixed frame comprises a main frame, a top frame, and a side frame, the main frame corresponds to the second side wall, the groove is formed on the main frame, and the main frame connects the top frame and the side frame.

18. The optical system as claimed in claim 17, wherein when viewed in a direction perpendicular to the first side wall, the main frame and the side frame do not overlap the protective frame, and the top frame at least partially overlaps the protective frame.

19. The optical system as claimed in claim 17, wherein when viewed in a direction parallel to the first and second side walls, the main frame and the top frame do not overlap the protective frame, and the side frame at least partially overlaps the protective frame.

20. The optical system as claimed in claim 17, wherein the output terminal of the circuit assembly is disposed on the top frame, and the side frame does not contact the circuit assembly.
